(19) United States
(12) Patent Application Publication
(10) Pub. No.: US 2011/0246747 A1
(43) Pub. Date: Oct. 6, 2011

(54) RECONFIGURABLE CIRCUIT USING VALID SIGNALS AND METHOD OF OPERATING RECONFIGURABLE CIRCUIT

(75) Inventors: Takashi HANAI, Yokohama (JP); Kiyomitsu Katou, Yokohama (JP); Takahiro Kubota, Yokohama (JP); Junji Sahoda, Yokohama (JP); Ichiro Kasama, Yokohama (JP); Kyoji Sato, Yokohama (JP); Shinichi Sutou, Yokohama (JP)

(73) Assignee: FUJITSU SEMICONDUCTOR LIMITED, Yokohama (JP)

(21) Appl. No.: 13/073,691

(22) Filed: Mar. 28, 2011

(30) Foreign Application Priority Data
Apr. 1, 2010 (JP) 2010-085470

(51) Int. Cl. G06F 15/76; G06F 9/02

(52) U.S. Cl. 712/29; 712/E09.002

(57) ABSTRACT

A reconfigurable circuit includes a data execution unit including a plurality of execution elements, each of which performs execution with respect to plural data upon the plural data being all in a valid state, and holds valid-state output data indicative of a result of the execution at an output node while all the plural data are in the valid state, a data selecting unit configured to connect between the execution elements in a reconfigurable manner, and a data input unit configured to supply input data to a series of execution elements to perform a series of executions, wherein a valid or invalid state of given data is specified by a valid signal accompanying and forming a pair with the given data, and the input data supplied from the data input unit to the data execution unit are fixed to valid-state constant data while the series of executions are performed.

### CROSS-REFERENCE TO RELATED APPLICATIONS

The present application is based upon and claims the benefit of priority from the prior Japanese Patent Application No. 2010-085470 filed on Apr. 1, 2010, with the Japanese Patent Office, the entire contents of which are incorporated herein by reference.

### FIELD

The disclosures herein generally relate to electronic circuits, and particularly relate to a reconfigurable circuit that can be dynamically reconfigured.

### BACKGROUND

A dynamic reconfigurable circuit (hereinafter referred to as a reconfigurable circuit) includes a data execution unit inclusive of a plurality of execution elements having various execution functions, and also includes a data selecting unit serving as a network for connecting between the execution elements. Based on configuration data that are externally set, settings are made in a reconfigurable manner with respect to execution instructions for the execution elements of the data execution unit and connections provided by the data selecting unit between the execution elements. The configuration data may be updated while the reconfigurable circuit is operating, thereby dynamically modifying execution instructions and connections between the execution elements. This allows the execution units to be shared in a time-division fashion, thereby reducing the size of hardware of the entire circuit. Further, a reconfigurable circuit may perform a pipeline operation, and is thus capable of processing a data stream at high speed.

The execution elements that provide execution functions exhibit different execution latencies, depending on the type of execution. In general, the number of execution cycles for completing an execution is relatively small for simple computation whereas the number of execution cycles for completing an execution is relatively long for complex computation. A given execution element may receive execution results from two preceding execution elements. In such a case, these execution results from the two execution elements may not become available at the same time due to different execution latencies, the order of executions, etc. In order to align the timings, a delay may be introduced to a data path along which the earlier execution result is supplied. Further, when a desired computation is implemented by combining various execution functions, the function to count the number of execution cycles for completing the computation may be provided for the purpose of notifying an external device of the completion of all the computation.

The delay circuit that introduces the above-noted delay is preferably designed such that the number of delay stages is adjustable to a desired number of cycles in order to ensure latitude in circuit configuration. The provision of such a delay circuit, however, gives rise to a problem of an increase in circuit size of the data execution unit. As the number of delay circuits increases, further, circuit size increases both in the data execution unit and in the data selecting unit. This causes reduction in the operating speed of paths passing through the data selecting unit. In order to implement the above-noted function to count the number of execution cycles for completing computation, a memory may be provided to store data indicative of the number of execution cycles for the maximum number of possible computations, and, also, a counter may be provided to count the number of execution cycles. This also adds to the problem of increases in circuit size. Such increases in circuit size grow larger as the number of possible combinations of execution functions and the number of types of execution functions increase, i.e., as desired versatility increases.
[Patent Document 1] Japanese Laid-open Patent Publication No. 2004-118713
[Patent Document 2] Japanese Laid-open Patent Publication No. 2008-92190
[Patent Document 3] Japanese Laid-open Patent Publication No. 2007-94847
[Patent Document 4] Japanese Laid-open Patent Publication No. 2009-75875

### SUMMARY

According to an aspect of the embodiment, a reconfigurable circuit includes a data execution unit including a plurality of execution elements, each of which performs execution with respect to plural data upon the plural data being all in a valid state, and holds valid-state output data indicative of a result of the execution at an output node thereof while all the plural data are in the valid state, a data selecting unit configured to connect between the execution elements in a reconfigurable manner, and a data input unit configured to store data as input data that are supplied to a series of execution elements connected through the data selecting unit to perform a series of executions, wherein a valid or invalid state of given data is specified by a valid signal indicative of a valid or invalid state, the valid signal accompanying and forming a pair with the given data, and the input data supplied from the data input unit to the data execution unit are fixed to valid-state constant data while the series of executions are performed.

According to an aspect of the embodiment, a method is provided to operate a reconfigurable circuit which includes a data execution unit including a plurality of execution elements, each of which performs execution with respect to plural data upon the plural data being all in a valid state, and holds valid-state output data indicative of a result of the execution at an output node thereof while all the plural data are in the valid state, a data selecting unit configured to connect between the execution elements in a reconfigurable manner, and a data input unit configured to store data as input data that are supplied to a series of execution elements connected through the data selecting unit to perform a series of executions. The method includes causing the input data supplied from the data input unit to the data execution unit to be fixed to valid-state constant data while the series of executions are performed.

According to an aspect of the embodiment, a reconfigurable circuit includes a data execution unit including a plurality of execution elements, each of which latches plural data in a simultaneous or sequential manner in an order in which the plural data become valid, and performs execution with respect to the plural data upon the plural data being all latched, thereby outputting valid-state data indicative of a result obtained by the execution, a data selecting unit configured to connect between the execution elements in a reconfigurable manner, and a data input unit configured to store data as input data that are supplied to a series of execution elements connected through the data selecting unit to perform a series of executions, wherein a valid or invalid state of given data is specified by a valid signal indicative of a valid or invalid state, the valid signal accompanying and forming a pair with the given data,

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an example of the configuration of a reconfigurable circuit;

FIGS. 2A and 2B are drawings for explaining the operation of an execution function unit;

FIG. 3 is a drawing illustrating an example of the configuration of a register unit;

FIG. 4 is a drawing illustrating an example of the configuration of a counter illustrated in FIG. 1;

FIG. 5 is a timing chart illustrating an example of the operation of the reconfigurable circuit illustrated in FIG. 1;

FIG. 6 is a drawing illustrating an example of the configuration of a reconfigurable circuit;

FIG. 7 is a drawing illustrating an example of the configuration of a register unit;

FIG. 8 is a drawing illustrating an example of the configuration of an execution completion detection unit;

FIG. 9 is a timing chart illustrating an example of the operation of the reconfigurable circuit illustrated in FIG. 6; and

FIG. 10 is a timing chart illustrating an example of the operation of a reconfigurable circuit in which an input data hold function is provided in each execution function unit.

### DESCRIPTION OF EMBODIMENTS

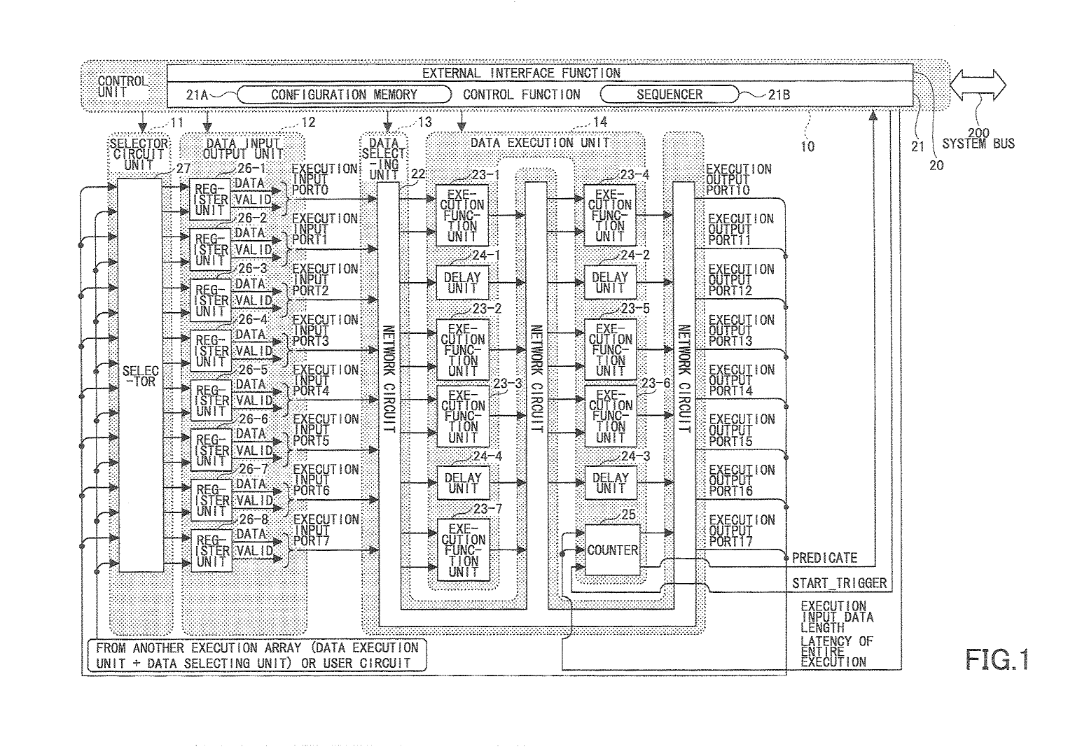

A description will first be given of a general configuration a reconfigurable circuit. FIG. 1 is a drawing illustrating an example of the configuration of a reconfigurable circuit. The reconfigurable circuit illustrated in FIG. 1 includes a control unit 10, a selector circuit unit 11, a data input output unit 12, a data selecting unit 13, and a data execution unit 14. The control unit 10 includes an external interface function 20 and a control function 21, and is connected to a system bus 200. The control function 21 serves to control operations of the entirety of the reconfigurable circuit. The control function 21 includes a configuration memory 21A and a sequencer 21B. The data execution unit 14 includes a plurality of execution function units 23-1 through 23-7, a plurality of delay units 24-1 through 24-4, and a counter 25. The number of the execution function units and the number of the delay units are examples only, and are not limited to these examples. The data selecting unit 13 includes a network circuit 22. The network circuit 22 connects in a reconfigurable manner between the execution function units 23-1 through 23-7, the delay units 24-1 through 24-4, and the counter 25 in the data execution unit 14. The data input output unit 12 includes a plurality of register units 26-1 through 26-8. The number of the register units 26-1 through 26-8 is only an example, and is not limited to this example. The selector circuit unit 11 includes a selector 27.

Executions performed by the execution function units 23-1 through 23-7 are specified by execution instructions included in configuration data. Connections between the execution function units 23-1 through 23-7 are specified by connection data included in configuration data. Such configuration data are stored in the configuration memory 21A. From a plurality of configuration data pieces stored in the configuration memory 21A, the sequencer 21B selects a configuration data piece indicative of a current operation type of the data selecting unit 13 and the data execution unit 14. The configuration data piece selected by the sequencer 21B is supplied to the data selecting unit 13 and the data execution unit 14, so that the data selecting unit 13 and the data execution unit 14 operate according to the operation type corresponding to the configuration data. The sequencer 21B successively selects configuration data pieces for provision to the data selecting unit 13 and the data execution unit 14, thereby successively updating the type of operation (i.e., contexts) of the data selecting unit 13 and the data execution unit 14.

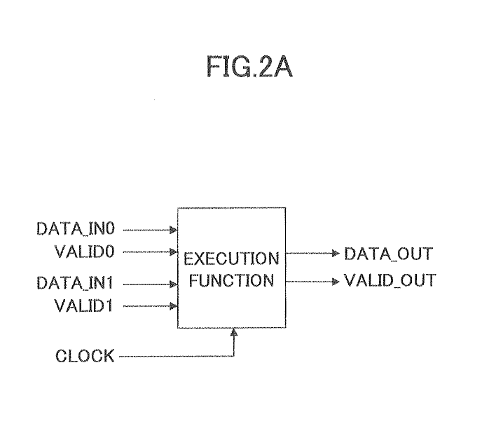

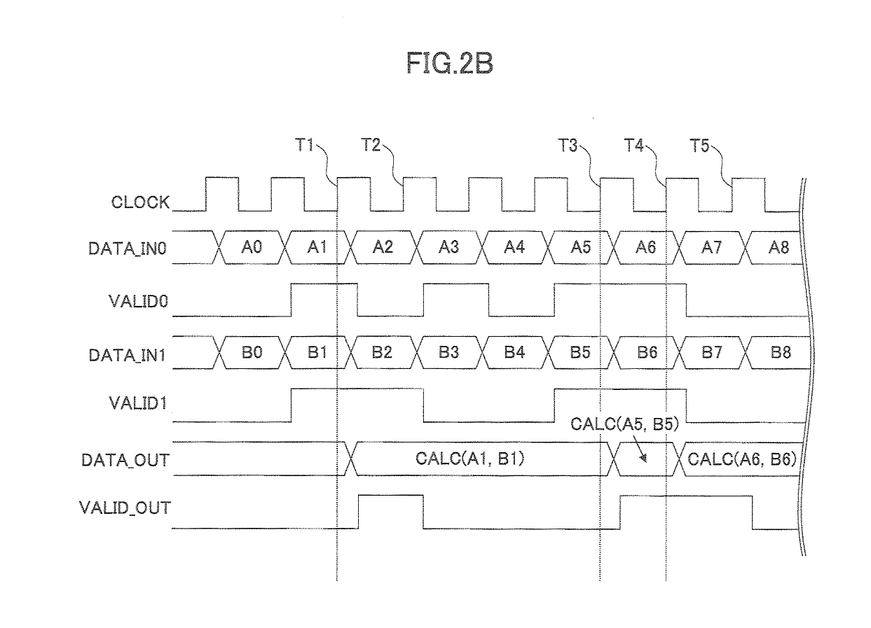

FIGS. 2A and 2B are drawings for explaining the operation of an execution function unit. FIG. 2A illustrates input signals and output signals of an execution function unit. As illustrated in FIG. 2A, the input signals of the execution function unit include two execution data inputs DATA_IN0 and DATA_IN1 and two valid signal inputs VALID0 and VALID1. The valid signal inputs VALID0 and VALID1 are provided in one-to-one correspondence to the execution data inputs DATA_IN0 and DATA_IN1, respectively, and serve to indicate the valid periods of the execution data inputs DATA_IN0 and DATA_IN1, respectively. For example, the valid signal input that is “0” indicates that the corresponding execution data input is invalid. The valid signal input that is “1” indicates that the corresponding execution data input is valid. The output signals of the execution function unit include an execution data output DATA_OUT and a valid signal output VALID_OUT. For example, the valid signal output that is “0” indicates that the corresponding execution data output is invalid. The valid signal output that is “1” indicates that the corresponding execution data output is valid. The execution function unit also receives a clock signal CLOCK. The execution function unit operates in synchronization with the clock signal CLOCK.

FIG. 2B illustrates changes in the input signals and output signals of the execution function unit. When both of the valid signal inputs VALID0 and VALID1 are “1” indicative of a data valid state at a rising edge of the clock signal CLOCK, the execution function unit performs execution with respect to the execution data inputs DATA_IN0 and DATA_IN1 provided at the time. The execution function unit updates its output signals with new execution results, thereby outputting the execution data output DATA_OUT with the valid signal output VALID_OUT set equal to “1”. In the example illustrated in FIG. 2B, the execution data output DATA_OUT of the execution function unit is updated in response to a rising edge T1 to become CALC(A1, B1) that is an execution result obtained for input data A1 and B1. The execution data output DATA_OUT is then updated in response to a rising edge T3 to become CALC(A5, B5) that is an execution result obtained for input data A5 and B5. The execution data output DATA_OUT is further updated in response to a rising edge T4 to become CALC(A6, B6) that is an execution result obtained for input data A6 and B6. The execution data output DATA_OUT of the execution function unit is kept to the current value until it is updated by a next execution data output. In FIG. 2B, the execution data output DATA_OUT is updated after a passage of the execution latency following a rising edge of the clock signal CLOCK that triggers the start of the execution. The length of latency varies depending on the type of execution. In general, the number of execution cycles for completing an execution is relatively small for simple computation whereas the number of execution cycles for completing an execution is relatively long for complex computation.

When at least one of the valid signal inputs VALID0 and VALID1 is “0” indicative of a data invalid state at a rising edge of the clock signal CLOCK, the valid signal output VALID_OUT becomes “0” indicative of an invalid state. In the example illustrated in FIG. 2B, the valid signal output VALID_OUT of the execution function unit changes from “1” indicative of a valid state to “0” indicative of an invalid state in response to a rising edge T2. Similarly, the valid signal output VALID_OUT of the execution function unit changes from “1” indicative of a valid state to “0” indicative of an invalid state in response to a rising edge T5. As illustrated in FIG. 2B, the time length from the rising edge of the clock signal CLOCK to the change to “0” of the valid signal output VALID_OUT may be equal to the length of latency for completing the execution.

The execution function unit may be configured such that the execution data output and the valid signal output are changed in synchronization with the clock signal CLOCK. When the execution function unit performs execution in response to the rising edge T3, for example, the execution data output DATA_OUT may be updated to a new execution result, and the valid signal output VALID_OUT may be set equal to “1” at the next rising edge T4. When at least one of the valid signal inputs VALID0 and VALID1 is “0” indicative of a data invalid state at the rising edge T4, the valid signal output VALID_OUT may change from “1” to “0” at the next rising edge T5. In this example, the latency of execution is equal to one clock cycle. However, the latency of execution is not limited to one clock cycle, and may be equal to any number of clock cycles. When the execution function unit performs execution in response to a given rising edge, for example, the execution data output DATA_OUT may be updated to a new execution result, and the valid signal output VALID_OUT may be set equal to “1” at a rising edge of the n-th following cycle. When at least one of the valid signal inputs VALID0 and VALID1 is “0” indicative of a data invalid state at the rising edge of the next following cycle, the valid signal output VALID_OUT may change from “1” to “0” at the rising edge of the n+1-th following cycle.

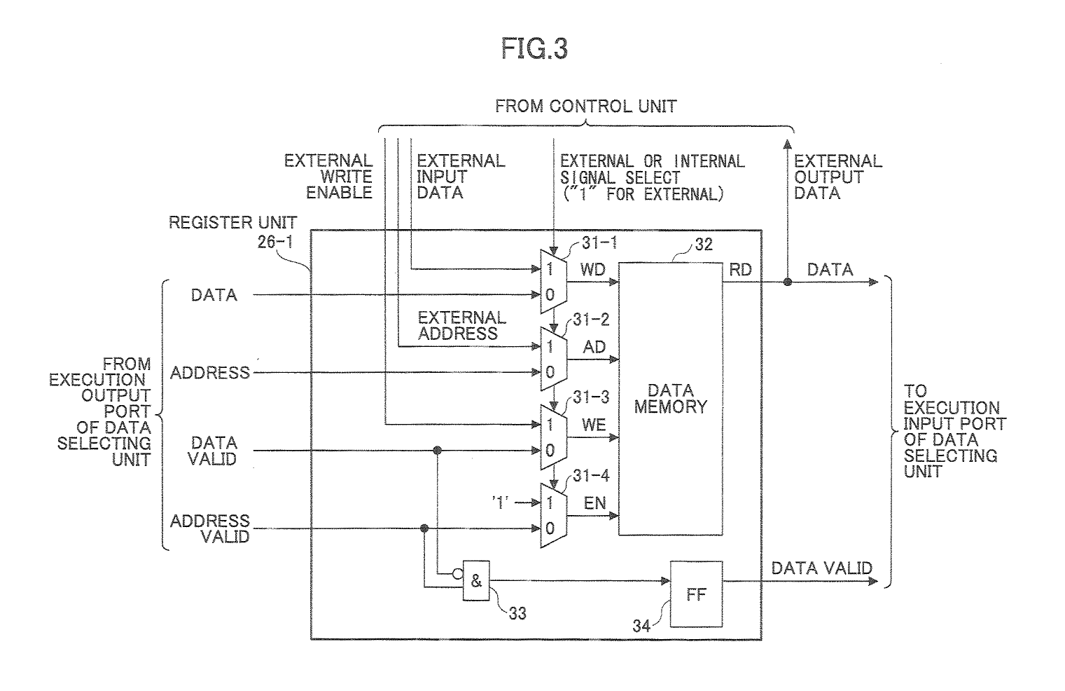

FIG. 3 is a drawing illustrating an example of the configuration of a register unit. FIG. 3 illustrates the configuration of the register unit 26-1 as an example. Each of the register units 26-1 through 26-8 may have the same or similar configuration. The register unit 26-1 includes selectors 31-1 through 31-4, a data memory 32, an AND gate 33, and a flip-flop 34.

The control unit 10 illustrated in FIG. 1 provides the selectors 31-1 through 31-4 with a selection control signal for selecting either an external signal or an internal signal. The selection control signal that is “0” causes the selectors 31-1 through 31-4 to select signals from an internal source. The selection control signal that is “1” causes the selectors 31-1 through 31-4 to select signals from an external source. The externally provided signals include external input data (i.e., data to be written), an external address (i.e., write address or read address), and an external write enable. When the selection control signal is “1” indicative of the selection of external signals, the external write enable is set to an asserted state to write the externally provided write data to the data memory 32 at the specified write address. When the selection control signal is “1” indicative of the selection of external signals, the external write enable is set to a negated state to read data as external output data from the specified read address in the data memory 32.

The internally provided signals may be signals supplied from the execution output ports (PORT10 through PORT17 illustrated in FIG. 1) of the data selecting unit 13 via the selector circuit unit 11, for example. Such signals include data, an address, a data valid, and an address valid. The data valid and the address valid serve as valid signals to indicate a valid or invalid state of the data and the address, respectively. When the selection control signal is “0” indicative of the selection of internal signals, the data valid and address valid are set to a value indicative of a valid state to write the internally provided write data to the data memory 32 at the specified write address. When the selection control signal is “0” indicative of the selection of internal signals, the data valid is set to a value indicative of an invalid state, and the address valid is set to a value indicative of a valid state, thereby to read data from the specified read address in the data memory 32. When this happens, the output of the AND gate 33 is set equal to “1”, which is then set in the flip-flop 34. As a result, the data valid output from the register unit 26-1 is set to “1” indicative of a valid state.

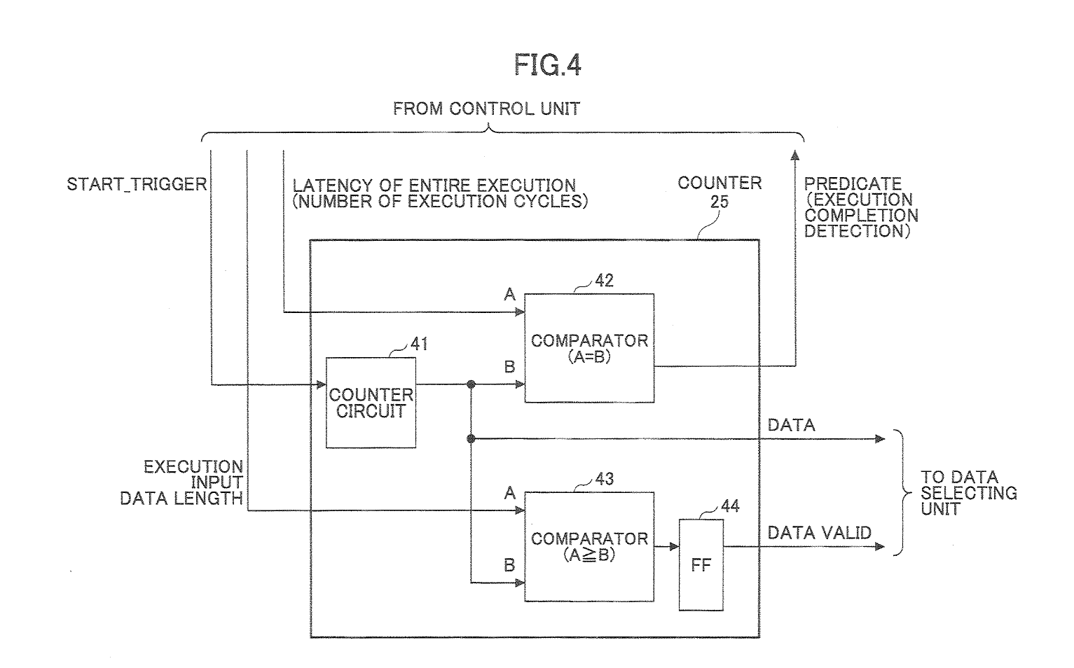

FIG. 4 is a drawing illustrating an example of the configuration of the counter 25 illustrated in FIG. 1. The counter 25 includes a counter circuit 41, a comparator 42, a comparator 43, and a flip-flop 44. The counter circuit 41 receives a start indicating signal START_TRIGGER that indicates the start of execution by the reconfigurable circuit based on the current configuration data (i.e., contexts). In response to the assertion of the start indicating signal START_TRIGGER, the counter circuit 41 starts counting the pulses of the clock signal to output a count value. The comparator 42 compares the count value output from the counter circuit 41 with the number of execution cycles indicative of the latency of entire execution, thereby asserting its output upon detecting a match between these two. The output of the comparator 42 is supplied to the control unit 10 as an execution completion detection signal PREDICATE. The comparator 43 compares the count value output from the counter circuit 41 with the execution input data length supplied from the control unit 10. When the output count value is no larger than the execution input data length, the comparator 43 sets its output to “1”, thereby setting “1” in the flip-flop 44. The counter 25 outputs the output count value of the counter circuit 41 as its output data, and also outputs the stored value of the flip-flop 44 as a data valid. The output data of the counter 25 is used as addresses for reading a series of input data from the register units of the data input output unit 12, so that the series of input data are subjected to pipeline processing performed by the reconfigurable circuit.

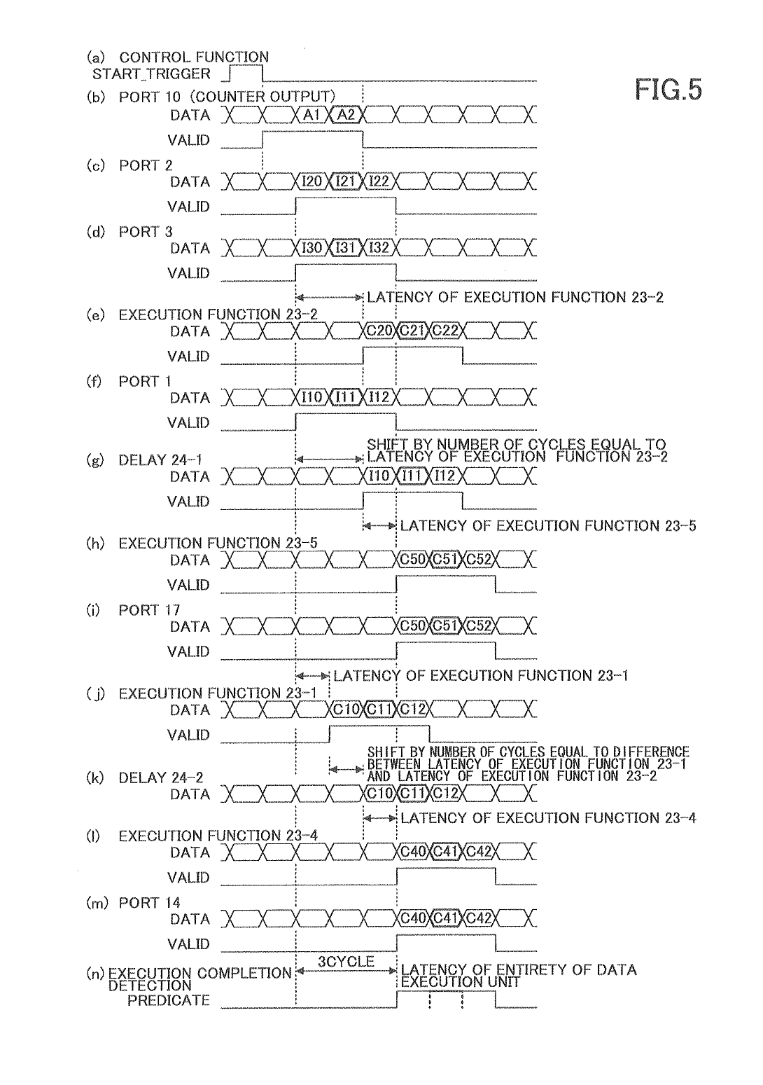

FIG. 5 is a timing chart illustrating an example of the operation of the reconfigurable circuit illustrated in FIG. 1. This example illustrates an operation by which three input data are successively processed in a pipelined manner. In this example, further, the data of the execution input ports PORT2 and PORT3 are executed by the execution function unit 23-2, and its execution result and the data of the execution input port PORT1 are executed by the execution function unit 23-5. The execution result of the execution function unit 23-5 is then output from the execution output port PORT17. Moreover, the data of the execution input ports PORT1 and PORT2 are executed by the execution function unit 23-1, and its execution result and the execution result of the execution function unit 23-2 are executed by the execution function unit 23-4. The execution result of the execution function unit 23-4 is then output from the execution output port PORT14. The data signals and valid signals of these ports and execution function units are illustrated in FIG. 5.

The control unit 10 makes settings to the data selecting unit 13 and the data execution unit 14 according to desired configuration data, and, also, writes input data to be processed to the data input output unit 12. After this, the control unit 10 sets the selection control signal of the data input output unit 12 illustrated in FIG. 3 to a value indicative of the selection of internal signals. Upon completing these settings, the control function 21 of the control unit 10 asserts the start indicating signal START_TRIGGER at the HIGH level as illustrated in FIG. 5-(a). In response, the counter 25 described in connection with FIG. 4 outputs address signals A0 through A2 and a valid signal from the execution output port PORT10 as illustrated in (b). The address signals A0 through A2 are supplied to desired register units of the data input output unit 12 illustrated in FIG. 1, so that data are read from the addresses specified by these address signals. In the example illustrated in FIG. 5, three data are read consecutively in the respective clock cycles from each of the execution input port PORT2 illustrated (c), the execution input port PORT3 illustrated (d), and the execution input port PORT1 illustrated (f).

Data I20 through I22 of the execution input port PORT2 illustrated in (c) and data I30 through I132 of the execution input port PORT3 illustrated in (d) are executed by the execution function unit 23-2. As illustrated in (e), execution results C20 through C22 are output with a delay of two cycles from the input data where the delay is equal to the latency of the execution function unit 23-2. In order to match the timing of the execution results C20 through C22, data I10 through I12 of the execution input port PORT1 illustrated in (f) are input into the delay unit 24-1 to be delayed by two cycles as illustrated in (g). The execution results C20 through C22 illustrated in (e) and the input data I10 through I12 illustrated in (g) are executed by the execution function unit 23-5. As illustrated in (h), execution results C50 through C52 are output with a delay of one cycle which is equal to the latency of the execution function unit 23-5. The execution results θ50 through C52 are output from the execution output port PORT17 as illustrated in (i).

Further, data I10 through I12 of the execution input port PORT1 illustrated in (f) and data I20 through I22 of the execution input port PORT2 illustrated in (c) are executed by the execution function unit 23-1. As illustrated in (j), execution results C10 through C12 are output with a delay of one cycle from the input data where the delay is equal to the latency of the execution function unit 23-1. In order to match the timing of the execution results C20 through C22, the execution results C10 through C12 illustrated in (j) are input into the delay unit 24-2 to be delayed by one additional cycle as illustrated in (k). The execution results C20 through C22 illustrated in (e) and the execution results C10 through C12 illustrated in (k) are executed by the execution function unit 23-4. As illustrated in (l), execution results C40 through C42 are output with a delay of one cycle which is equal to the latency of the execution function unit 23-4. The execution results C40 through C42 are output from the execution output port PORT14 as illustrated in (m).

The execution completion detection signal PREDICATE illustrated in (h) is generated by the counter 25 illustrated in FIG. 4 based on a value indicative of the latency of the entire data execution supplied from the control unit 10. The execution completion detection signal PREDICATE may be asserted at the HIGH level during the period in which the execution results are output from the execution output ports. In this example, the execution results C50 through C52 are output from the execution output port PORT17 as illustrated in (i), and the execution results C40 through C42 are output from the execution output port PORT14 as illustrated in (m). The execution completion detection signal PREDICATE is kept at “1” during the period in which these execution results are being output.

In response to the assertion of the execution completion detection signal PREDICATE, the control unit 10 sets the selection control signal of the data input output unit 12 to a value indicative of the selection of external signals. Further, the control unit 10 places the external write enable in a negated state and supplies a read address, thereby reading data from the data memories 32 of the data input output unit 12.

In the configuration described above, the number of delay stages of the delay units 24-1 through 24-4 is preferably settable to a desired number of cycles as previously described. The provision of such delay units, however, gives rise to a problem of an increase in circuit size of the data execution unit. Further, as the number of delay circuits increases, further, circuit size increases both in the data input output unit 12 and in the data selecting unit 13. This causes reduction in the operating speed of paths passing through the data selecting unit 13. Also, the provision of the counter 25 gives rise to a problem of an increase in circuit size. Such increases in circuit size grow larger as the number of possible combinations of execution functions and the number of types of execution functions increase, i.e., as desired versatility increases.

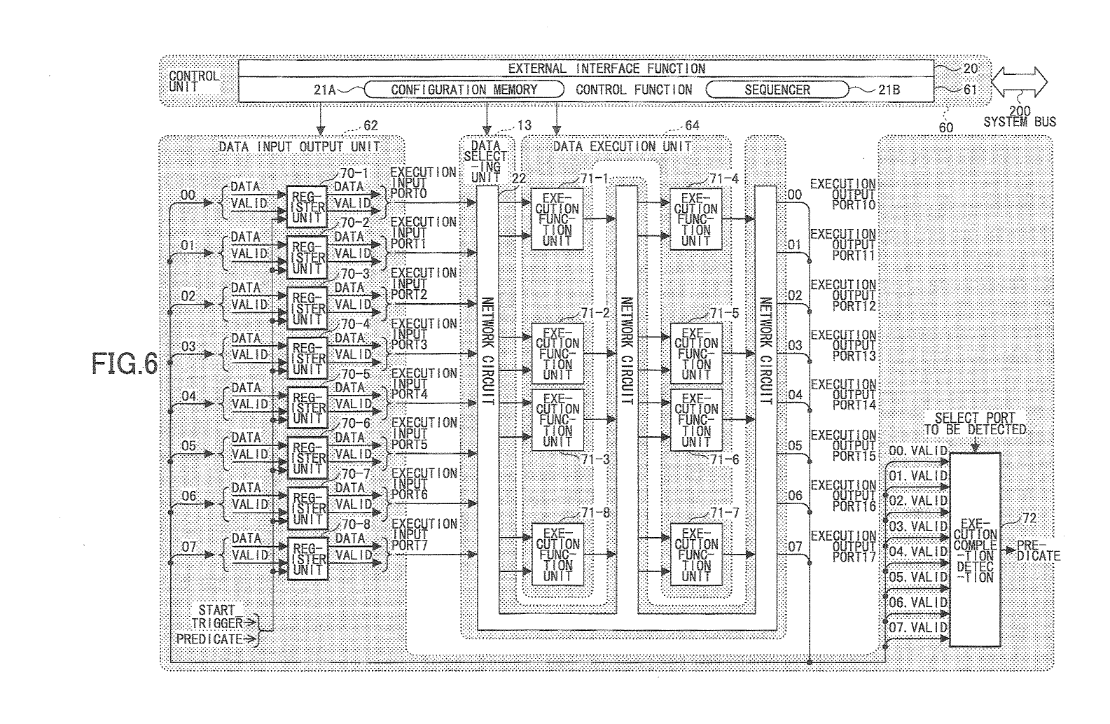

In the following, embodiments will be described with reference to the accompanying drawings. FIG. 6 is a drawing illustrating an example of the configuration of a reconfigurable circuit. In FIG. 6, the same elements as those of FIG. 1 are referred to by the same or similar numerals, and a description thereof will be omitted as appropriate.

The reconfigurable circuit illustrated in FIG. 6 includes a control unit 60, a data input output unit 62, a data selecting unit 13, and a data execution unit 64. The control unit 60 includes an external interface function 20 and a control function 61, and is connected to a system bus 200. The control function 61 serves to control operations of the entirety of the reconfigurable circuit. The control function 21 includes a configuration memory 21A and a sequencer 21B. The reconfigurable circuit illustrated in FIG. 1 performs pipeline execution with respect to a series of data whereas the reconfigurable circuit illustrated in FIG. 6 does not start execution with respect to next data until the execution of current data is completed. In this sense, the reconfigurable circuit illustrated in FIG. 6 plays a role of coprocessor as viewed from a CPU connected to the system bus 200.

The data execution unit 64 includes a plurality of execution function units 71-1 through 71-8. The number of the execution function units is only an example, and is not limited to this example. The network circuit 22 of the data selecting unit 13 connects between the execution function units 71-1 through 71-8 of the data execution unit 64 in a reconfigurable manner. The data input output unit 62 includes a plurality of register units 70-1 through 70-8 and an execution completion detection unit 72. The number of the register units 70-1 through 70-8 is only an example, and is not limited to this example. The data selecting unit 13 includes execution output ports PORT10 through PORT17 connected to the execution completion detection unit 72. Signals indicative of a valid or invalid state of one or more execution results obtained by a series of executions are supplied to the execution completion detection unit 72 through one or more of the execution output ports PORT10 through PORT17. Output data O0 through O7 of the execution output ports PORT10 through PORT17 are also supplied to the register units 70-1 through 70-8, respectively.

Executions performed by the execution function units 71-1 through 71-8 are specified by execution instructions included in configuration data. Connections between the execution function units 71-1 through 71-8 are specified by connection data included in configuration data. Such configuration data are stored in the configuration memory 21A. From a plurality of configuration data pieces stored in the configuration memory 21A, the sequencer 21B selects a configuration data piece indicative of a current operation type of the data selecting unit 13 and the data execution unit 64. The configuration data piece selected by the sequencer 21B is supplied to the data selecting unit 13 and the data execution unit 64, so that the data selecting unit 13 and the data execution unit 64 operate according to the operation type corresponding to the configuration data. The sequencer 21B successively selects configuration data pieces for provision to the data selecting unit 13 and the data execution unit 64, thereby successively updating the type of operation (i.e., contexts) of the data selecting unit 13 and the data execution unit 64.

An execution function unit performs the operation described in connection with FIG. 2. The execution function unit performs execution with respect to plural input execution data when the plural (two in the example of FIG. 2) input execution data are all in a valid state simultaneously. The execution function unit holds valid data indicative of a result of the execution at its output node while the plural input execution data are all in a valid state simultaneously. The valid or invalid state of execution data is specified by a valid signal indicative of a valid or invalid state in such a manner that the valid signal accompanies and forms a pair with the execution data. When both of the valid signal inputs VALID0 and VALID1 are “1” indicative of a data valid state at a rising edge of the clock signal CLOCK, the execution function unit performs execution with respect to the execution data inputs DATA_T_NO and DATA_IN1 provided at the time. The execution function unit updates its output signals with new execution results, thereby outputting the execution data output DATA_OUT with the valid signal output VALID_OUT set equal to “1”. The execution data output DATA_OUT of the execution function unit is kept to the current value until it is updated by a next execution data output. When at least one of the valid signal inputs VALID0 and VALID1 is “0” indicative of a data invalid state at a rising edge of the clock signal CLOCK, the valid signal output VALID_OUT becomes “0” indicative of an invalid state.

The latency of execution may be the number of clock cycles responsive to the type of execution (i.e., execution instruction). The latency of execution is not limited to one clock cycle, and may be equal to any number of clock cycles. When the execution function unit performs execution in response to a given rising edge, for example, the execution data output DATA_OUT may be updated to a new execution result, and the valid signal output VALID_OUT may be set equal to “1” at a rising edge of the n-th following cycle. When at least one of the valid signal inputs VALID0 and VALID1 is “0” indicative of a data invalid state at the rising edge of the next following cycle, the valid signal output VALID_OUT may change from “1” to “0” at the rising edge of the n+1-th following cycle. The latency of a valid signal is equal to the latency for outputting an execution result. Such latency of a valid signal may be implemented by using a shift register having stages that are equivalent in number to the latency for performing execution.

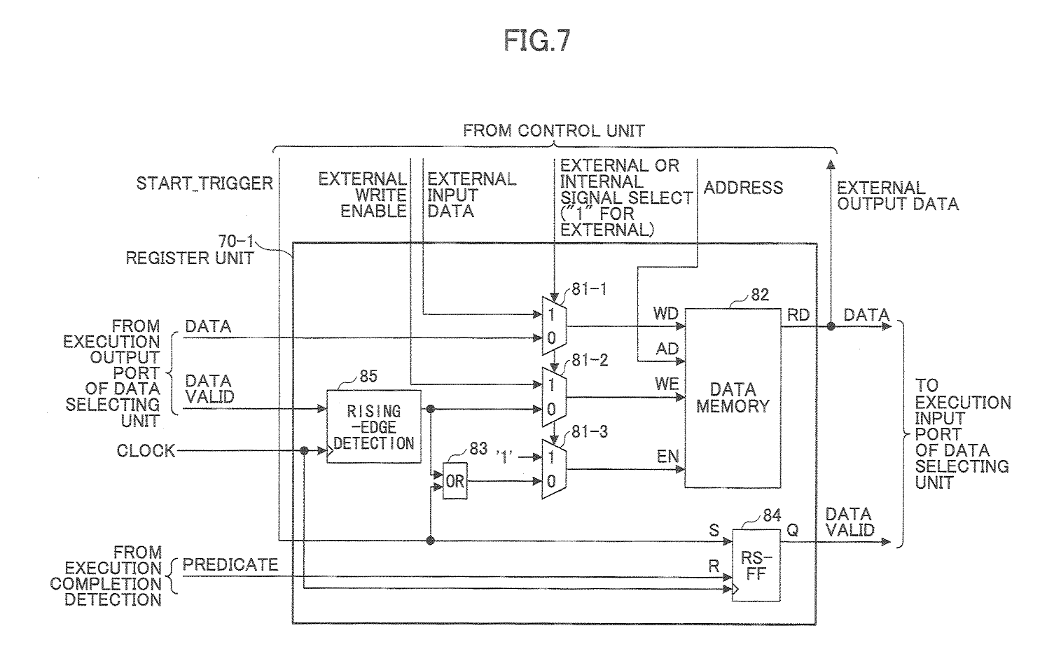

FIG. 7 is a drawing illustrating an example of the configuration of a register unit. FIG. 7 illustrates the configuration of the register unit 70-1 as an example. Each of the register units 70-1 through 70-8 may have the same or similar configuration. The register unit 70-1 includes selectors 81-1 through 81-3, a data memory 82, an OR gate 83, a flip-flop 84, and a rising-edge detection circuit 85.

The control unit 60 illustrated in FIG. 6 provides the selectors 81-1 through 81-3 with a selection control signal for selecting either an external signal or an internal signal. The selection control signal that is “0” causes the selectors 81-1 through 81-3 to select signals from an internal source. The selection control signal that is “1” causes the selectors 81-1 through 81-3 to select signals from an external source. It may be noted that the externally provided signal for the selector 81-3 is fixed to “1”. The externally provided signals include external input data (i.e., data to be written) and an external write enable. An external address (i.e., write address or read address) is directly supplied from the control unit 60 to the data memory 82. When the selection control signal is “1” indicative of the selection of external signals, the external write enable is set to an asserted state to write the externally provided write data to the data memory 82 at the specified write address. When the selection control signal is “1” indicative of the selection of external signals, the external write enable is set to a negated state to read data as external output data from the specified read address in the data memory 82.

Internally provided signals are the signals O0 through O7 supplied from the execution output ports PORT10 through PORT17 of the data selecting unit 13. Each of the signals O0 through O7 includes a data signal and a data valid signal. The data valid signal serves to indicate a valid or invalid state of the data signal. With the selection control signal being “0” indicative of the selection of internal signals, execution result data obtained as a result of a series of executions are written to a specified write address in the data memory 82. Specifically, the rising-edge detection circuit 85 generates a HIGH pulse for the length of one cycle upon the valid signal of the execution result being changed to “1”. This HIGH pulse is supplied to the data memory 82 as a write enable signal WE, so that the execution result data is written to the data memory 82 as write data WD. With the selection control signal being “0” indicative of the selection of internal signals, the start indicating signal START_TRIGGER is asserted, so that this asserted signal is supplied to the data memory 82 as an enable signal EN. When this happens, the write enable signal WE is in a negated state, so that data is read from the specified read address in the data memory 82. Further, in response to the start indicating signal START_TRIGGER, the flip-flop 84 is set to “1”, so that the output data valid is set to “1” indicative of a valid state. Namely, in response to the assertion of the start indicating signal START_TRIGGER, the data input output unit 62 starts supplying valid data to the data execution unit 64. The flip-flop 84 is reset to “0” in response to the assertion of the execution completion detection signal PREDICATE supplied from the execution completion detection unit 72, which will be described later. Namely, in response to the assertion of the execution completion detection signal PREDICATE, the data input output unit 62 stops supplying valid data to the data execution unit 64.

The data memory 82 of the register unit 70-1 is configured to hold read data in an output state (i.e., to maintain the read data in a state in which the read data is being output at the output node). Namely, when a data read operation is performed with respect to a specified address, read data RD is output from the data memory 82, and is thereafter maintained in such an output state. The data input output unit 62 has data stored in the data memory 82 where this data is to be applied to execution function units connected through the data selecting unit 13 to perform a series of executions. While the series of executions are being performed, the data output of the data memory 82 is held in an output state as described above, so that the input data supplied from the data input output unit 62 to the data execution units 64 is fixed to a constant value in a valid state. Namely, unlike the case illustrated in FIG. 5 in which different data values are supplied in different cycles from the data input output unit to perform pipeline operations, the data input output unit 62 keeps supplying a constant data value for the duration of plural cycles in which a series of executions is performed.

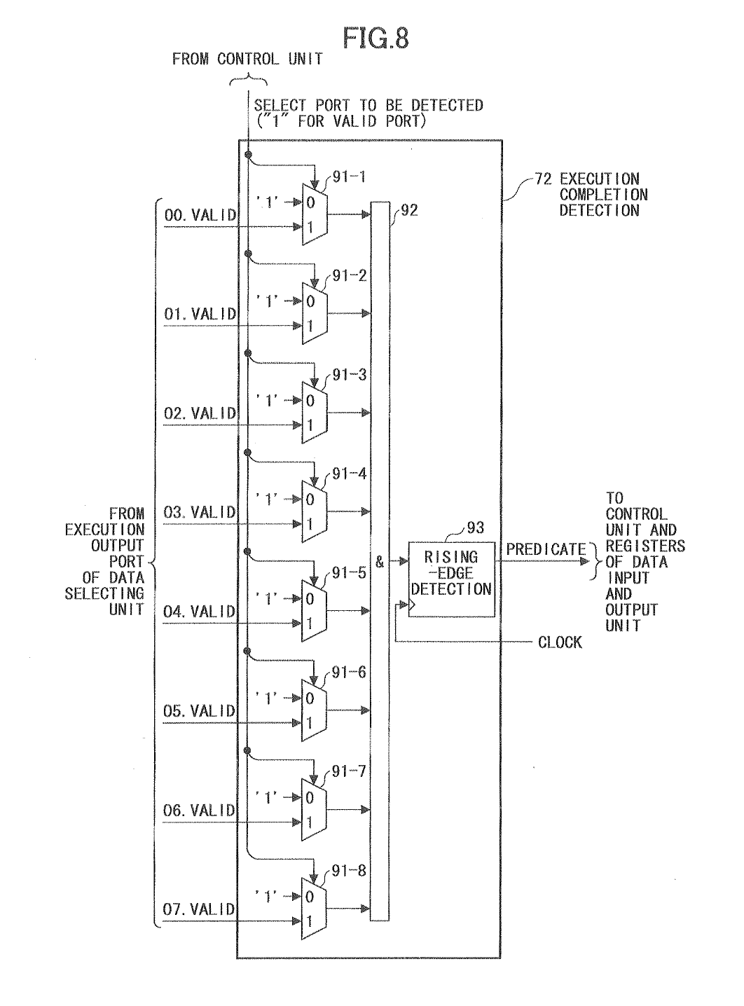

FIG. 8 is a drawing illustrating an example of the configuration of the execution completion detection unit 72. As previously described, the execution output ports PORT10 through PORT17 of the data input output unit 62 are connected to the execution completion detection unit 72. Specifically, valid signals O0.VALID through O7.VALID for the respective output data O0 through O7 of the execution output ports PORT10 through PORT17 are supplied to the execution completion detection unit 72. The execution completion detection unit 72 asserts the execution completion detection signal PREDICATE upon one or more execution results of a series of executions being all simultaneously in a valid state.

The execution completion detection unit 72 includes selectors 91-1 through 91-8, an AND gate 92, and a rising-edge detection circuit 93. Selection control signals to the selectors 91-1 through 91-8 are supplied from the control unit 60. These selection control signals control whether to supply the valid signals O0.VALID through O7.VALID to the data memory 82 through the selectors 91-1 through 91-8, respectively. Specifically, a selector that receives a selection control signal being “1” selects the valid signal for provision to the data memory 82. Further, a selector that receives a selection control signal being “0” selects a fixed value of “1” for provision to the data memory 82. The data memory 82 sets its output to “1” when all the selected valid signals are “1”. The rising-edge detection circuit 93 detects a rising edge upon the output of the AND gate 92 being changed from “0” to “1”, thereby generating a HIGH pulse for the length of one cycle. This HIGH pulse for one cycle corresponds to the asserted state of the execution completion detection signal PREDICATE. The execution completion detection signal PREDICATE is supplied to the control unit 60 and the data input output unit 62. In this manner, the selectors in the execution completion detection unit 72 are controlled by the selection control signals, thereby selecting output ports that are taken into consideration when deciding whether relevant signals indicative of a valid or invalid state all indicate a valid state simultaneously.

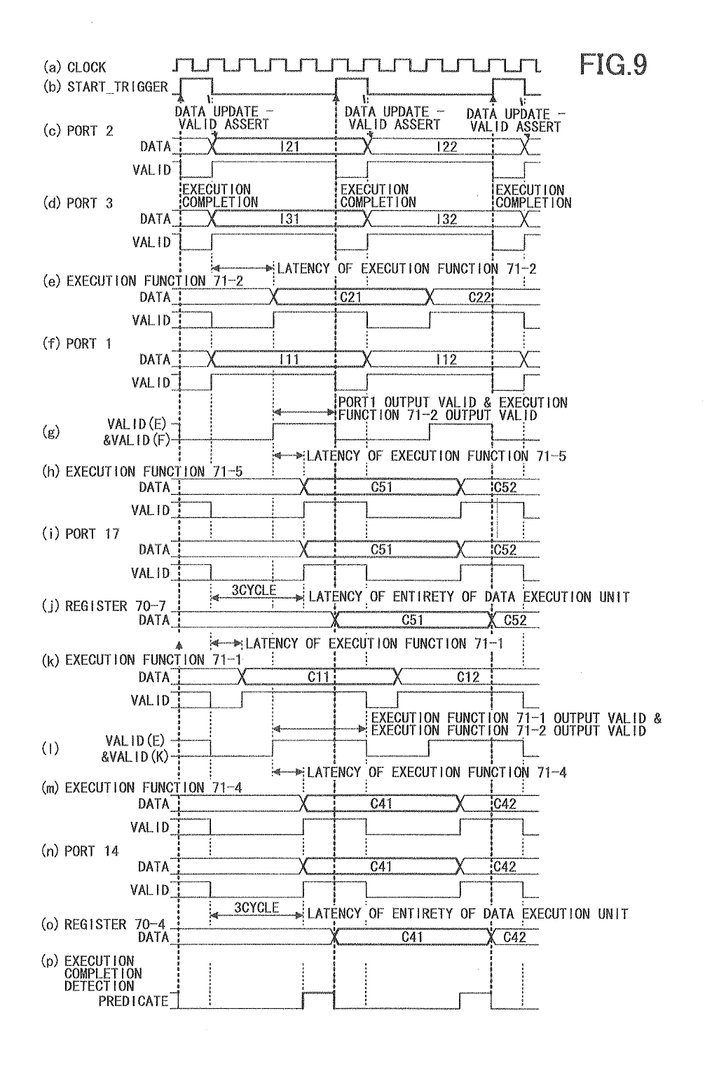

FIG. 9 is a timing chart illustrating an example of the operation of the reconfigurable circuit illustrated in FIG. 6. In this example, further, the data of the execution input ports PORT2 and PORT3 illustrated in FIG. 6 are executed by the execution function unit 71-2, and its execution result and the data of the execution input port PORT1 are executed by the execution function unit 71-5. The execution result of the execution function unit 71-5 is then output from the execution output port PORT17. Moreover, the data of the execution input ports PORT1 and PORT2 are executed by the execution function unit 71-1, and its execution result and the execution result of the execution function unit 71-2 are executed by the execution function unit 71-4. The execution result of the execution function unit 71-4 is then output from the execution output port PORT14. The data signals and valid signals of these ports and execution function units are illustrated in FIG. 9.

The control unit 60 makes settings to the data selecting unit 13 and the data execution unit 64 according to desired configuration data, and, also, writes input data to be processed to the data input output unit 62. After this, the control unit 60 sets the selection control signal of the data input output unit 62 described in connection with FIG. 7 to a value indicative of the selection of internal signals. Upon completing these settings, the control function 61 of the control unit 60 asserts the start indicating signal START_TRIGGER at the HIGH level as illustrated in FIG. 9-(b). As was described in connection with FIG. 7, valid-state data are output from the specified address in the data input output unit 62 in response to the assertion of the start indicating signal START_TRIGGER. In the example illustrated in FIG. 9, one datum is output as a constant data value maintained for the duration of plural clock cycles from each of the execution input port PORT2 illustrated (c), the execution input port PORT3 illustrated (d), and the execution input port PORT1 illustrated (f).

Data I21 of the execution input port PORT2 illustrated in (c) and data I31 of the execution input port PORT3 illustrated in (d) are executed by the execution function unit 71-2. As illustrated in (e), an execution result C21 is output with a delay of two cycles from the input data where the delay is equal to the latency of the execution function unit 71-2. An AND operation is performed between a valid signal for the execution result C21 illustrated in (e) and a valid signal for the data I11 of the execution output port PORT1 illustrated in (f), and the resulting AND logic value is illustrated in (g). As the AND logic value illustrated in (g) becomes “1”, the execution result C21 illustrated in (e) and the input data I11 illustrated in (f) are executed by the execution function unit 71-5. As illustrated in (h), an execution result C51 are output with a delay of one cycle which is equal to the latency of the execution function unit 71-5. This execution result C51 is output from the execution output port PORT17 as illustrated in (i). The output value of the execution output port PORT17 is written to the register unit 70-7 as illustrated in (j).

Further, data I11 of the execution input port PORT1 illustrated in (f) and data I21 of the execution input port PORT2 illustrated in (c) are executed by the execution function unit 71-1. As illustrated in (k), an execution result C11 is output with a delay of one cycle from the input data where the delay is equal to the latency of the execution function unit 71-1. An AND operation is performed between a valid signal for the execution result C11 illustrated in (k) and a valid signal for the execution result. C21 illustrated in (e), and the resulting AND logic value is illustrated in (l). As the AND logic value illustrated in (g) becomes “1”, the execution result C21 illustrated in (e) and the execution result C11 illustrated in (k) are executed by the execution function unit 71-4. As illustrated in (m), an execution result C41 is output with a delay of one cycle which is equal to the latency of the execution function unit 71-4. This execution result C41 is output from the execution output port PORT14 as illustrated in (n). The output value of the execution output port PORT14 is written to the register unit 70-4 as illustrated in (o).

The execution completion detection unit 72 asserts the execution completion detection signal PREDICATE illustrated in (p) upon one or more execution results (i.e., the output of PORT14 and the output of PORT17 in the example of FIG. 9) of a series of executions being all simultaneously in a valid state. Specifically, a rising edge is detected in an AND logic value obtained by performing an AND operation between the valid signal of the execution output port PORT17 illustrated in (i) and the valid signal of the execution output port PORT14 illustrated in (n), followed by generating a HIGH pulse lasting for the duration of one clock cycle from the timing of the detected rising edge. The HIGH pulse lasting for one clock cycle is the execution completion detection signal PREDICATE.

In response to the assertion of the execution completion detection signal PREDICATE, the data input output unit 62 stops supplying valid data to the data execution unit 64. Namely, at each of the execution input ports PORT2, PORT3, and PORT1 illustrated in FIG. 9-(c), (d), and (f), respectively, the valid signal changes “1” to “0” in response to the assertion of the execution completion detection signal PREDICATE. At each of the execution, results illustrated in (e), (h), (k), and (m), also, the valid signal changes from “1” to “0” in the next clock cycle in response to the above-noted changes in the valid signals.

In response to the assertion of the execution completion detection signal PREDICATE, the control unit 60 updates the read address supplied to the data input output unit 62 to a next read address for the purpose of starting a next series of executions. After this, the control unit 60 asserts the start indicating signal START_TRIGGER at the HIGH level as illustrated in (b). As a result, a series of executions identical to the above-described series of executions will be performed with respect to next data. It may be noted that the contexts may also be updated at this time to perform a new series of executions different from the previous one. The control unit 60 also reads the read data C51 from the register unit 70-7 illustrated in (j) and the read data C41 from the register unit 70-4 illustrated in (o) as execution results of the series of executions.

In the reconfigurable circuit illustrated in FIG. 6 described above, data supplied from the data input output unit 12 is maintained in a signal activated state (i.e., data supply state) while a series of executions are being performed. With this arrangement, each execution function unit for performing execution based on data supplied from the data input output unit 12 can maintain its output in a state in which the execution result in a valid state is being output. Accordingly, for any given execution function unit that receives plural data, each of the plural data is held in a valid state without being inactivated, so that it suffices for the given execution function unit to start execution after waiting for all the data to be simultaneously in a valid state. Unlike the reconfigurable circuit illustrated in FIG. 1, thus, a delay circuit for achieving timing alignment is no longer provided. Further, an estimation of the latency for completing execution, a register for storing data indicative of the latency, and a counter circuit illustrated in FIG. 4 are no longer necessary. In place of these circuits, the execution completion detection unit 72 having a simple configuration comprised of selectors, an AND gate, and the like is provided for the purpose of detecting execution completion. With this arrangement, the reconfigurable circuit illustrated in FIG. 6 has a reduce circuit size compared with the reconfigurable circuit illustrated in FIG. 1.

The reconfigurable circuit illustrated in FIG. 6 may be modified such that data supplied from the data input output unit 62 to the data execution unit 64 is not maintained in a valid state for the duration of a series of execution, but is maintained in a valid state only for one cycle, for example, before being placed in an invalid state. In such a case, a given execution function unit that receives plural data may encounter an instance in which the valid states of the plural data may not match each other. It is thus not sensible for the given execution function unit to wait for all the data to be simultaneously in a valid state. The functions of the execution function units 71-1 through 71-8 thus may be modified such that a latch is provided at an input portion. The latch may store input data in response to the input data valid signal being changed to a value indicative of a valid state.

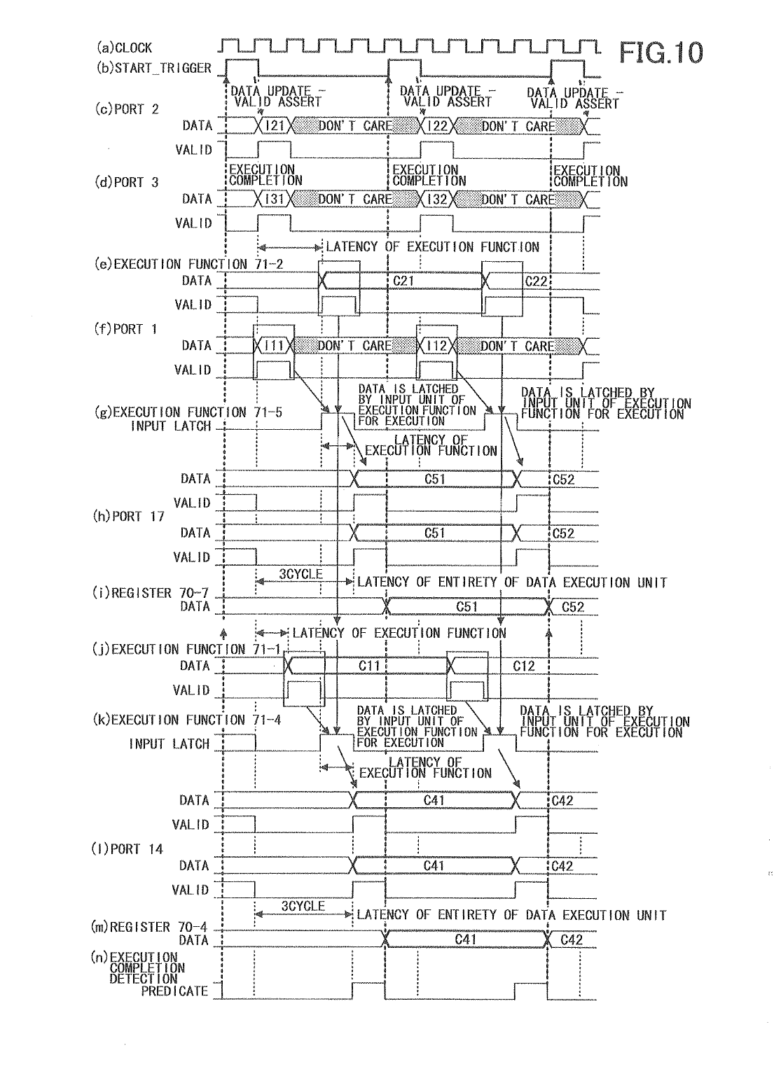

FIG. 10 is a timing chart illustrating an example of the operation of the reconfigurable circuit in which an input data hold function is provided in each execution function unit. This example is directed to the operation that performs the same or similar executions as those illustrated in FIG. 9. As illustrated in FIG. 10-(b), the control function 61 of the control unit 60 asserts the start indicating signal START_TRIGGER at the HIGH level. Valid-state data are output from the specified address in the data input output unit 62 in response to the assertion of the start indicating signal START_TRIGGER. In the example illustrated in FIG. 10, one datum is output from each of the execution input port PORT2 illustrated (c), the execution input port PORT3 illustrated (d), and the execution input port PORT1 illustrated (f), and is maintained in a valid state only for one clock cycle.

Data I21 of the execution input port PORT2 illustrated in (c) and data I31 of the execution input port PORT3 illustrated in (d) are executed by the execution function unit 71-2. As illustrated in (e), an execution result C21 is output with a delay of two cycles from the input data where the delay is equal to the latency of the execution function unit 71-2. The execution function unit 71-5, for example, performs execution with respect to the execution result C21 illustrated in (e) and the data I11 of the execution input port PORT1 illustrated in (f). In so doing, the input latch latches the execution result C21 and the data I11, and, then, the execution is performed to generate the execution result C51 as illustrated in (g). As illustrated in (g), an execution result C51 are output with a delay of one cycle which is equal to the latency of the execution function unit 71-5. In the execution function unit 71-5, the operation to latch the execution result C21 is immediately performed in response to “1” of the valid signal for the execution result C21. Also, the operation to latch the data I11 is immediately performed in response to “1” of the valid signal for the data I11.

In the configuration described above, an execution function unit latches plural data in a simultaneous or sequential manner in the order in which they become valid. When all the plural data are latched, the execution function unit performs execution with respect to these plural data, thereby to output valid data indicative of a result obtained from the execution. Further, the execution completion detection unit may be configured to latch and hold the valid signals O0.VALID through O7.VALID supplied thereto. The execution completion detection unit may then assert the execution completion detection signal PREDICATE upon one or more execution results of a series of executions being all in a valid state. Unlike the reconfigurable circuit illustrated in FIG. 1, the above-noted configuration no longer uses a delay circuit for achieving timing alignment. However, the degree of circuit size reduction is not as significant as in the case of the configuration illustrated in FIG. 6 because latch circuits equal in number to data bits are provided at the input portion of each of the execution function units 71-1 through 71-8.

According to at least one embodiment, data supplied from the data input unit in the reconfigurable circuit is maintained in a signal activated state (i.e., data supply state) while a series of executions are being performed. With this arrangement, each execution function unit for performing execution based on data supplied from the data input unit can maintain its output in a state in which the execution result in a valid state is being output. Accordingly, for any given execution function unit that receives plural data, each of the plural data is held in a valid state without being inactivated, so that it suffices for the given execution function unit to start execution after waiting for all the data to be simultaneously in a valid state. A delay circuit for achieving timing alignment is thus no longer provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A reconfigurable circuit, comprising:
a data execution unit including a plurality of execution elements, each of which performs execution with respect to plural data upon the plural data being all in a valid state, and holds valid-state output data indicative of a result of the execution at an output node thereof while all the plural data are in the valid state;
a data selecting unit configured to connect between the execution elements in a reconfigurable manner; and
a data input unit configured to store data as input data that are supplied to a series of execution elements connected through the data selecting unit to perform a series of executions,
wherein a valid or invalid state of given data is specified by a valid signal indicative of a valid or invalid state, the valid signal accompanying and forming a pair with the given data, and the input data supplied from the data input unit to the data execution unit are fixed to valid-state constant data while the series of executions are performed.

2. The reconfigurable circuit as claimed in claim 1, further comprising an execution completion detection unit configured to assert an execution completion detection signal upon one or more execution results of the series of executions being all simultaneously in a valid state.

3. The reconfigurable circuit as claimed in claim 2, wherein, in response to the assertion of the execution completion detection signal, the data input unit stops supplying valid-state data to the data execution unit.

4. The reconfigurable circuit as claimed in claim 2, wherein the data selecting unit includes a plurality of output ports connected to the execution completion detection unit, and supplies signals indicative of a valid or invalid state of the one or more execution results of the series of executions to the execution completion detection unit through one or more of the output ports,
and wherein the execution completion detection unit is configured to select one or more of the output ports that are taken into consideration when deciding whether the signals indicative of a valid or invalid state all indicate a valid state simultaneously.

5. The reconfigurable circuit as claimed in claim 1, further comprising a control unit configured to assert a start indicating signal indicative of start of the series of executions to the data input unit, wherein in response to the assertion of the start indicating signal, the data input unit starts supplying valid-state data to the data execution unit.

6. A method of operating a reconfigurable circuit, comprising:
a data execution unit including a plurality of execution elements, each of which performs execution with respect to plural data upon the plural data being all in a valid state, and holds valid-state output data indicative of a result of the execution at an output node thereof while all the plural data are in the valid state;
a data selecting unit configured to connect between the execution elements in a reconfigurable manner; and
a data input unit configured to store data as input data that are supplied to a series of execution elements connected through the data selecting unit to perform a series of executions,
the method comprising:
causing the input data supplied from the data input unit to the data execution unit to be fixed to valid-state constant data while the series of executions are performed.

7. The method as claimed in claim 6, further comprising asserting an execution completion detection signal upon one or more execution results of the series of executions being all simultaneously in a valid state.

8. The method as claimed in claim 7, further comprising stopping supplying valid-state data from the data input unit to the data execution unit in response to the assertion of the execution completion detection signal.

9. The method as claimed in claim 7, further comprising:
supplying signals indicative of a valid or invalid state of the one or more execution results of the series of executions through one or more of output ports of the data selecting unit; and
selecting one or more of the output ports that are taken into consideration when deciding whether the signals indicative of a valid or invalid state all indicate a valid state simultaneously.

10. The method as claimed in claim 6, further comprising starting supplying valid-state data from the data input unit to the data execution unit in response to the assertion of a start indicating signal indicative of start of the series of executions.

11. A reconfigurable circuit, comprising:
a data execution unit including a plurality of execution elements, each of which latches plural data in a simultaneous or sequential manner in an order in which the plural data become valid, and performs execution with respect to the plural data upon the plural data being all latched, thereby outputting valid-state data indicative of a result obtained by the execution;
a data selecting unit configured to connect between the execution elements in a reconfigurable manner; and
a data input unit configured to store data as input data that are supplied to a series of execution elements connected through the data selecting unit to perform a series of executions,
wherein a valid or invalid state of given data is specified by a valid signal indicative of a valid or invalid state, the valid signal accompanying and forming a pair with the given data,

12. The reconfigurable circuit as claimed in claim 11, further comprising an execution completion detection unit configured to assert an execution completion detection signal upon one or more execution results of the series of executions being all in a valid state.
